(19) United States
(12) Patent Application Publication
(10) Pub. No.: US 2005/0043913 A1
(43) Pub. Date: Feb. 24, 2005

(54) Method of determining the level of structural coverage testing of test cases which are written for a program that does not provide for structural coverage testing

(76) Inventors: Rex Hyde, South Jordan, UT (US); Thomas B. Sawyer, Riverton, UT (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 10/644,048

(22) Filed: Aug. 19, 2003

(51) Int. Cl. G06F 19/00

(52) U.S. Cl. 702/119

(57) ABSTRACT

A method of determining the level of structural coverage of RBT test cases, which are written for a program that does not provide for structural coverage testing, includes the steps of: (1) providing RBT test cases with associated inputs and outputs; (2) providing a structural coverage test tool; (3) converting the inputs and outputs to acceptable formats for the structural coverage test tool; (4) supplying such converted inputs and outputs to the structural coverage test tool; and (5) operating the coverage test tools; thereby to determine the level of structural coverage of such converted RBT test cases.

### TECHNICAL FIELD

The present invention relates generally to an improved method for determining the level of structural coverage of Requirements-Based Testing (“RBT”) test cases, which are written for a program that does not provide for determinations of structural coverage.

### BACKGROUND ART

In many applications, computer software is written in state logic to form a decision tree. For example, the target code may be written in Boolean logic, and also has statement blocks, input/output handling, subroutine calls and exits, modified condition and decision coverage. After the software is written, it is sometimes necessary to perform structural coverage testing of such software, in addition to RBT. For example, as written, the program may contain “dead code” or “deactivated code”, or may need to have “additional requirements” or “derived requirements” added to the requirements specification. The general function of structural coverage testing is to ensure that all calls, statements and decisions branches and paths of the decision tree are being queried or exercised to a desired level defined in the controlling standard.

In some cases, the chosen test tool may already have the capability of performing structural coverage testing. For example, a program currently offered by IBM, known as IBM Rational Test RealTime (“TestRT”), does provide for structural coverage testing.

However, in many instances, it is beneficial to use existing laboratory assets for Requirements-Based Testing using test tools which do not provide the capability of structural coverage testing. For example, it may be necessary to have various sensors or transducers associated with the actual physical hardware to be tested. These transducers are then used to generate signals indicative of different conditions imposed on the hardware. Thus, it is preferred to actually use the hardware itself for such testing. If the system were to be tested with the TestRT test tool, one may not be able to use the hardware itself. Rather, one would have to simulate or model the hardware in the TestRT tool. Such modeling could introduce the opportunity for errors and inconsistencies. In other words, in TestRT, the modeled system would be a simulated environment, and not the actual physical hardware itself. In some applications, such as airborne systems, there are government standards, such as DO-178B, that provide guidelines for software-based airborne systems.

An illustration might serve to clarify this point. Suppose that it is desired that in an airborne aircraft, the flaps still move symmetrically in the same direction within a tolerance of plus or minus 0.2 degrees. A programmer might then postulate an elementary program such as:
IF the absolute value of the difference in the angles of the flaps is less than or equal to 0.2 degrees AND if the weight on the wheels equals 0 AND if the computed air speed (CAS) is greater than 40 knots, THEN okay; otherwise, if CAS<40 knots OR weight on wheels equals 0, THEN failed; ELSE failed.

During verification and validation testing, the tester might wish to pose certain logical test cases at the boundaries so as to verify compliance. For example, in the above illustration, the testing protocol might generate five test cases:
1. If the difference in angle between both the flaps is less than 0.2 degrees.
2. At boundary limit of −0.2 degrees.
3. At boundary limit of +0.2 degrees.
4. Test out of bounds at greater than +0.2 degrees.
5. Test out of bounds at less than −0.2 degrees.
   These last two tests, 4 and 5, are known as “robustness testing”.

If the nominal test cases and robustness testing were to be conducted in a program that does not offer structural coverage testing, because of the strictures of DO-178B, it would be necessary to manually test the system to validate that all paths in the logical decision tree have been exercised. To do this, one might have to recreate or simulate the system in a structural coverage testing program. However, this would require duplication and modeling of the RBT testing already done on the physical hardware.

Accordingly, it would be generally desirable to provide a means for determining the level of structural coverage testing of RBT test cases which are written for a test tool that does not provide for such structural coverage reporting.

### DISCLOSURE OF THE INVENTION

The present invention broadly provides an improved method of determining the level of structural coverage of RBT test cases which are written for a program that does not provide for structural coverage testing. The improved method broadly comprises the steps of: (1) providing RBT test cases with associated inputs and outputs; (2) providing a structural coverage test tool; (3) converting the inputs and outputs of the RBT test cases to acceptable formats for the coverage test tool; (4) providing such converted inputs and outputs to the coverage test tool; and (5) operating the coverage test tools; thereby to determine the level of structural coverage of such converted RBT test cases.

In one embodiment, the RBT test cases are written to verify or validate target code.

In one form, the structural coverage test tool may be IBM Rational Test RealTime software, offered by International Business Machines Corporation, of One New Orchard Road, Armonk, N.Y. 14504. The program that does not provide the structural coverage may be TestStand or LabView, which is available from National Instruments Corporation, of 11500 North MoPac Expressway, Austin, Tex. 78759. The inputs and outputs of the program may be provided first to an Excel® (a registered trademark of Microsoft Corporation, of One Microsoft Way, Redmond, Wash. 98052) spreadsheet, prior to conversion.

Accordingly, the general object of the invention is to provide an improved method of determining the level of structural coverage of RBT test cases which have been written for a program that does not provide for structural coverage testing.

Another object is to provide a method of determining the level of structural coverage of RBT test cases which avoids the need to unnecessarily simulate or model a test system in a structural coverage test tool.

These and other objects and advantages will become apparent from the foregoing and ongoing written specification, the drawings, and the appended claims.

### BRIEF DESCRIPTION OF THE DRAWINGS

FIG. 1 is a blocked diagram of hardware for performing the indicated method.

FIG. 2 is a flow chart showing the series of steps involved in practicing the improved method.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

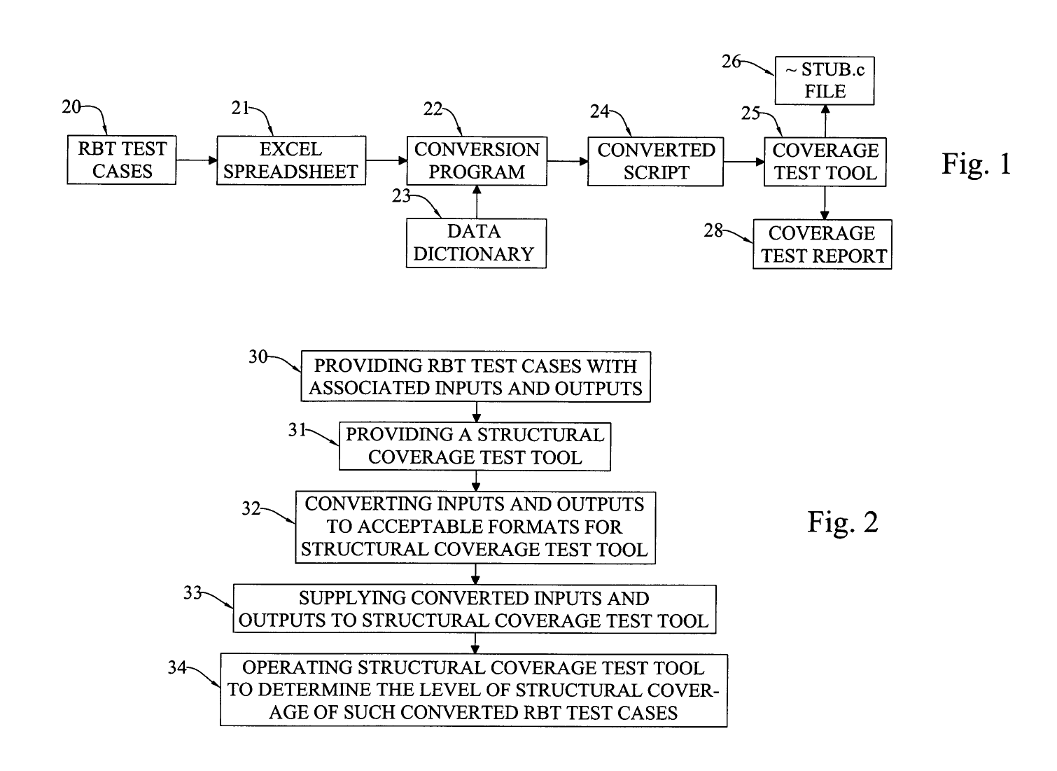

Referring now to the drawings, and, more particularly, to FIG. 1 thereof, a series of RBT test cases is indicated as being provided in block 20. These various test cases may be provided on a spreadsheet, such as that offered by Excel®, as indicated in block 21. The inputs and outputs of the RBT test cases are typically written in a program that does not provide for structural coverage testing. Similarly, the data displayed in the spreadsheet, contains the similar inputs and outputs.

The invention provides an improved converter, indicated at box 22, which is provided with inputs from a data dictionary, containing signal name to code variable tracing, indicated at box 23. The function of the converter is to take the inputs and outputs of the RBT test cases, and to convert them to an acceptable format, indicated at box 24, that may be provided to a coverage test tool, indicated at box 25. Coverage test tool is arranged to provide an input from a stub file simulating hardware inputs and outputs, indicated at box 26, and to selectively generate suitable reports, indicated at 28.

The steps performed by the improved method are graphically illustrated in FIG. 2. Viewing FIG. 2 along side of FIG. 1, the improved method comprises the steps of providing the RBT test cases with associated inputs and outputs, as indicated in box 30. This corresponds to box 20 in FIG. 1. The method also includes the provision of a structural test tool, indicated at box 31. The structural coverage test tool is indicated at box 25 in FIG. 1. The method then includes the step of converting the inputs and outputs to acceptable formats for the coverage test tool. This is indicated in box 32 of FIG. 2, which corresponds to box 22 in FIG. 1. The converted inputs, and outputs, as indicated in box 24, are then supplied to the coverage test tool as indicated in box 33. The coverage test tool is operated to determine the level of structural coverage of the converted RBT test cases. Thus, by use of the improved method, one does not have to recreate, simulate, model or duplicate the original RBT test cases in the structural coverage test tool. Rather, the data from the RBT test cases is exported and converted to an acceptable format, and is then supplied to the coverage test tool for structural coverage analysis.

Modifications

The present invention expressly contemplates that many changes and modifications may be made. For example, the inputs and outputs of the RBT test cases may be stored and recorded in a spreadsheet, such as that offered by Excel®, prior to conversion. While the program in which the RBT test cases are postulated may be Test-Stand or LabView, other programs may be used as well. Similarly, the structural coverage test tool is not limited to TestRT, but specifically includes other types of programs that provide for such structural coverage testing.

Accordingly, while the preferred form of the improved method has been shown and described, and several modifications thereof discussed, persons in this art will readily appreciate that various additional changes and modifications may be made without departing from the spirit of the invention, as defined and differentiated by the following claims.

1. The method of determining the level of structural coverage of RBT test cases, which are written for a program that does not provide for structural coverage testing, comprising the steps of:
providing RBT test cases with associated inputs and outputs;
providing a structural coverage test tool;
converting said inputs and outputs to acceptable formats for said coverage test tool;
supplying such converted inputs and outputs to said coverage test tool; and
operating said coverage test tool;
thereby to determine the level of structural coverage of such converted RBT test cases.

2. The method as set forth in claim 1 wherein said RBT test cases are written to verify or validate target code.

3. The method as set forth in claim 1 wherein said structural coverage test tool is IBM Rational Test RealTime.

4. The method as set forth in claim 1 wherein said inputs and outputs are provided to an Excel® spreadsheet.
